(19) United States
(12) Patent Application Publication
(10) Pub. No.: US 2010/0333141 A1
(43) Pub. Date: Dec. 30, 2010

(54) APPARATUS AND METHOD FOR EDITING A LIST OF DIGITAL BROADCAST CHANNELS

(75) Inventor: Young Seok KANG, Yongin-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/823,712

(22) Filed: Jun. 25, 2010

(30) Foreign Application Priority Data
Jun. 25, 2009 (KR) 10-2009-0056896

(51) Int. Cl. H04N 5/445

(52) U.S. Cl. 725/44

(57) ABSTRACT

Disclosed is an apparatus and method for editing a list of digital broadcast channels. A list of channels listed in order set according to channel information is displayed. At least one of the channels in the list is selected according to a user's input, and temporarily stored. When a user selects a position in the listed channels, at least one selected channel is moved to the selected position and displayed thereon. A list of channels is stored that reflects the order of channels into which at least one selected channel is moved.

### PRIORITY

This application claims priority under 35 U.S.C. 119(a) to an application filed in the Korean Intellectual Property Office on Jun. 25, 2009, and assigned Serial No. 10-2009-0056896, the contents of which are incorporated herein by reference.

### BACKGROUND OF THE INVENTION

1. Field of the Invention

The present invention relates generally to digital broadcast systems, and more particularly, to an apparatus and method that can edit a list of digital broadcast channels according to a user's intuition.

2. Description of the Related Art

In analog television broadcasts, picture and sound are encoded to and transmitted via respective analog signals. In contrast, audio and video signals in digital broadcast television are encoded to and conveyed via one digital signal, and they can be compressed without deteriorating the quality. Therefore, a digital television broadcast can allocate 4-8 channels to a frequency band corresponding to one channel in analog television broadcasts. A digital television broadcast allows information to be easily processed by computers. It can also allow for bidirectional communication, by providing information requested by viewers.

In digital broadcasts, audio and video signals are compressed and modulated by compression and multiple modulation technology that is employed in communication and computer systems. That is, digital broadcasts also refer to multimedia technology that combines broadcast, communication, and computer technology. In North America and Europe, digitalization is also popular in satellite systems, cable televisions, and terrestrial broadcasting systems.

With the development of broadcast technology and the popularization of a hybrid Set-Top-Box (STB), the number of channels has dramatically increased. However, conventional digital broadcasts only allow users to edit a list of digital broadcast channels by a function of storing or deleting a particular channel, which makes it difficult for users to manage an increased number of channels. Accordingly, there is a need in the art for methods to simplify the process of editing and searching for channels.

### SUMMARY OF THE INVENTION

The present invention has been made in view of the above problems, and provides an apparatus and method that allows users to easily edit a list of digital broadcast channels according to the user's preference.

In accordance with an embodiment of the present invention, a method for editing a list of digital broadcast channels includes displaying a list of channels listed in order set according to channel information, selecting at least one of the channels in the list according to a user's input, and moving, when a user selects a position in the listed channels, at least one selected channel to the selected position and displaying it thereon.

In accordance with another embodiment of the present invention, an apparatus is provided for editing a list of digital broadcast channels includes a broadcast receiver for receiving channel information, a display unit for displaying a list of channels listed in order set according to channel information, an input unit for receiving a user's input, and a controller for detecting whether at least one of the channels in the list is selected according to the user's input, and moving, when the user selects a position in the listed channels, at least one selected channel to the selected position and displaying it thereon.

In accordance with another embodiment of the present invention, a method for editing a list of digital broadcast channels includes temporarily storing a reproducing channel when a channel selection input is detected while the channel is being reproduced, reproducing an altered channel when a channel alteration is detected, and moving, when a channel edit command is input, the temporarily stored channel to a preset position and displaying it thereon.

In accordance with another embodiment of the present invention, an apparatus for editing a list of digital broadcast channels includes a broadcast receiver for receiving channel information, a display unit for displaying a list of channels listed in order set according to channel information, an input unit for receiving a user's input, and a controller for temporarily storing, when a channel selection input is detected, a channel that is reproducing a broadcast, reproducing, when a channel alteration is detected, the altered channel, moving, when a channel edit confirmation command is input, the temporarily stored channel in a preset position, and displaying it thereon.

### BRIEF DESCRIPTION OF THE DRAWINGS

The features and advantages of the present invention will become more apparent from the following detailed description in conjunction with the accompanying drawings, in which:

FIG. 1 illustrates a portable terminal according to an embodiment of the present invention;

FIG. 2A to FIG. 2E are screens that illustrate a method for editing a list of channels, according to an embodiment of the present invention;

FIG. 3 illustrates a method for editing a list of digital broadcast channels, according to an embodiment of the present invention; and

FIG. 4 illustrates a method for editing a list of digital broadcast channels, according to another embodiment of the present invention.

### DETAILED DESCRIPTION OF EMBODIMENTS OF THE INVENTION

Hereinafter, embodiments of the present invention are described in detail with reference to the accompanying drawings. The same reference numbers are used throughout the drawings to refer to the same or similar parts. Detailed descriptions of well-known functions and structures incorporated herein may be omitted for the sake of clarity and conciseness.

In the following embodiments, although the method for editing a list of digital broadcast channels is explained as being applied to a set-top-box for receiving digital broadcast and a TV system in which is installed a set-top-box or is connected to an external set-top-box, it should be understood that the method can be applied to various types of portable terminals with a digital broadcast receiver.

For example, it will be appreciated that the portable terminal according to the present invention can be applied to all information communication devices, multimedia devices, and their applications, such as a mobile communication terminal, a mobile phone, a Personal Digital Assistant (PDA), a smart phone, an International Mobile Telecommunication 2000 (IMT-2000) terminal, a Universal Mobile Telecommunication Service (UMTS) terminal, a laptop computer, and a personal computer.

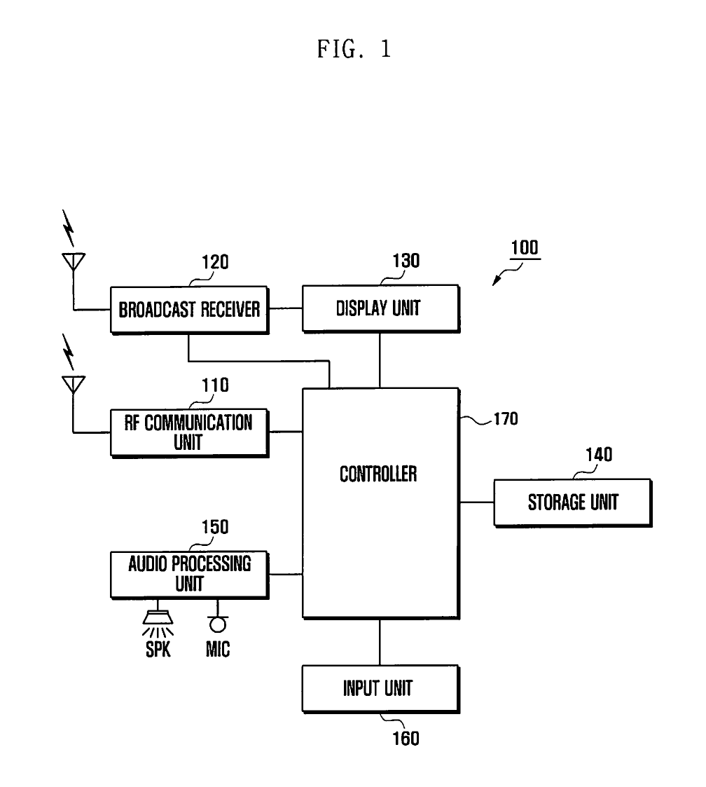

FIG. 1 illustrates a portable terminal according to an embodiment of the present invention.

Referring to FIG. 1, the portable terminal 100 includes a Radio Frequency (RF) communication unit 110, a broadcast receiver 120, a display unit 130, a storage unit 140, an audio processing unit 150, an input unit 160, and a controller 170.

The RF communication unit 110 is linked to a mobile communication network and performs wireless communication. The RF communication unit 110 includes an RF module and a baseband module (not shown). The RF module is configured to include an RF transmitter for up-converting the frequency of signals to be transmitted and amplifying the signals and an RF receiver for low-noise amplifying received RF signals and down-converting the frequency of the received RF signals. The baseband module modulates a signal to be transmitted by channel-encoding and interleaving operations, and provides the modulated signal to the RF module. The baseband module also processes a signal from the RF module by demodulation, equalization, channel decoding, and deinterleaving operations.

The broadcast receiver 120 receives digital broadcasts. The broadcast receiver 120 receives broadcast data, via a preset band, according to the control of the controller 170, where the received broadcast data corresponds to a service channel selected by the user. The broadcast receiver 120 processes the received broadcast data of the service channel and outputs audio, video, and broadcast information, respectively.

In the Digital Video Broadcasting-Handheld (DVB-H) method, the broadcast receiver 120 receives broadcast signals according to the time slicing technique, and extracts Transport Stream (TS) packets from the received broadcast signals. After that, the broadcast receiver 120 extracts a datagram according to IPv6 or IPv4 from the TS packets that are processed via an error correction, such as a MultiProtocol Encapsulation—Forward Error Correction (MPE-FEC). Next, the broadcast receiver 120 extracts data from the datagram, according to the FiLe delivery over Unidirectional Transport/Asynchronous Layered Coding (FLUTE/ALC) and Real-time Transport Protocol (RTP) protocols. The data extracted according to the FLUTE/ALC protocol may be an Electronic Service Guide (ESG). The data extracted according to the RTP protocol may be audio and video data.

ESG contains information regarding broadcast channels and is stored in the storage unit 140 according to the control of the controller 170. ESG can be received and updated according to a preset period.

The display unit 130 displays menus of the portable terminal, user data, and function settings information, along with additional information. In an embodiment of the present invention, the display unit 130 displays video data of digital broadcasts received from the broadcast receiver 120 or the controller 170. The display unit 130 is implemented with a Liquid Crystal Display (LCD). If the LCD as the display unit 130 is implemented with a touch screen, it can also serve to perform part or all of the functions of the input unit 160.

In an embodiment of the present invention, the display unit 130 displays in preset order a list of channels extracted from data, such as ESG. The display unit 130 also displays a list of channels edited according to a user's input.

The storage unit 140 may be a memory and/or storage media for storing such information as user data and application programs. In an embodiment of the present invention, the storage unit 140 stores a list of channels extracted from data, such as ESG, received by the broadcast receiver 120, or a list of channels edited according to a user's input.

The audio processing unit 150 plays back audio signals, output from the controller 170, via a SPeaKer (SPK) or transfers audio signals, input via a MICrophone (MIC), to the controller 170.

The input unit 160 generates key signals according to a user's input and outputs them to the controller 170. The key signals are related to the user's settings and the function control of the portable terminal. The input unit 160 includes a plurality of keys for receiving numerical or alphabetical information. It also includes functions keys for setting a variety of functions.

The controller 170 controls the signal flow of the elements in the portable terminal, such as the RF communication unit 110, the broadcast receiver 120, the display unit 130, the storage unit 140, the audio processing unit 150, and the input unit 160. To this end, the controller 170 may further include function modules.

The controller 170 controls the display unit 130 to display channels according to a user's input.

When the controller 170 detects that at least one of the channels is selected according to a user's input and the user selects a certain position in the listed channels, the controller 170 moves at least one selected channel to the selected position and displays it thereon. After that, the controller 170 temporarily stores at least one selected channel. When the controller 170 receives a request for deleting the temporarily stored at least one selected channel, the channel is stored in a preset folder.

In addition, when the controller 170 detects a channel selection input while a channel is being reproduced, it temporarily stores the reproduced channel. When the controller 170 detects a channel alteration, it reproduces the altered channel. When the controller 170 receives a channel edit confirmation input, it moves the temporarily stored channel to a set position and displays it thereon. In that case, the controller 170 moves the temporarily stored channel before or after the channel that is altered and being reproduced, and displays it thereon.

The portable terminal 100 may further include a data communication connector, a recharging connector, and units having added-on functions. The data communication connector is connected with a camera module and external digital devices, and outputs and receives data thereto and therefrom. Examples of the units are digital audio source playback modules, such as an MPEG Layer Audio 3 (MP3) module.

Due to the spread of digital convergence devices, the portable terminals are too various to list their modifications in this description. However, it will be easily appreciated by those skilled in the art that the other units equivalent to the above-listed units may be further included to the portable terminal 100 according to the present invention.

According to an embodiment of the present invention, if the digital broadcast device is a digital broadcast TV system that is equipped with a built-in set-top-box or connected to an external set-top-box, the input unit 160 may be a remote controller and the set-top-box may include the broadcast receiver 120 and the storage unit 140. The TV set includes the display unit 130, the audio processing unit 150, the input unit 160, and the controller 170. In that case, the controller 170 may be included in the set-top-box or the TV set.

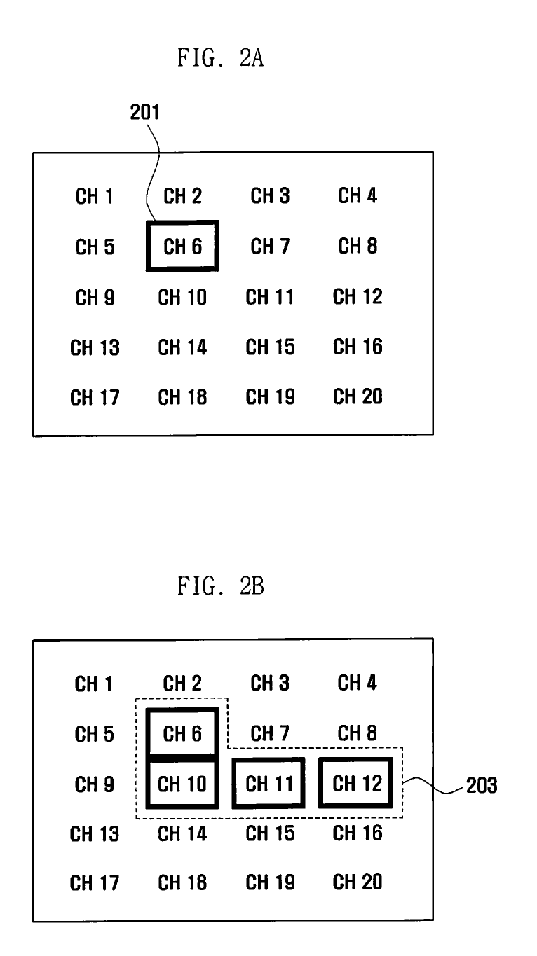

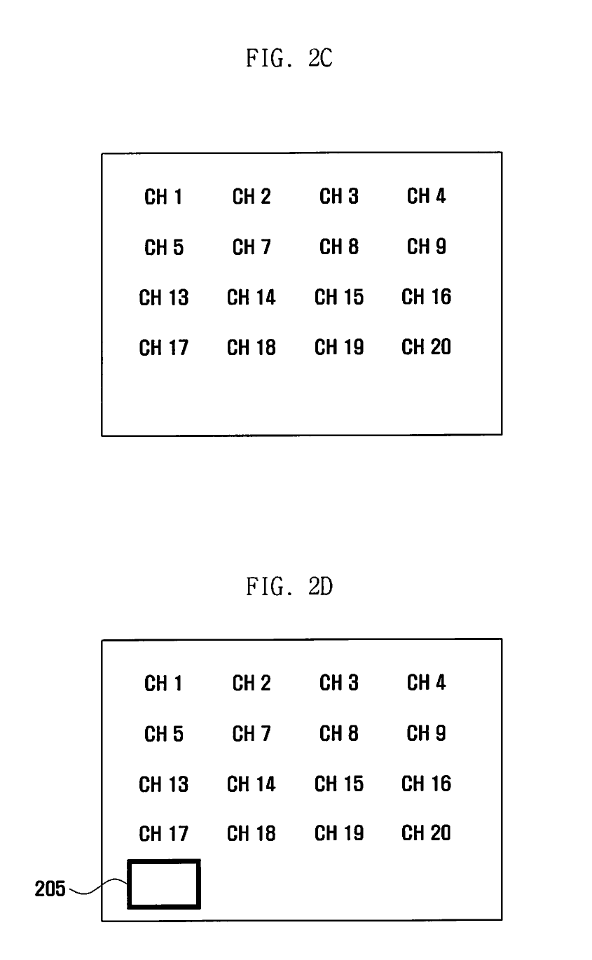

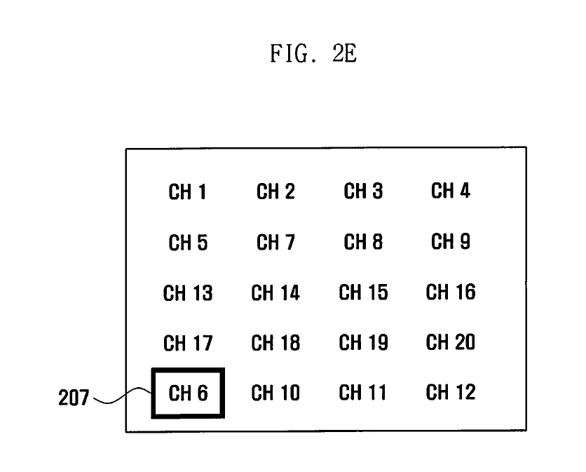

FIG. 2A to FIG. 2E are screens that illustrate a method for editing a list of channels, according to an embodiment of the present invention.

As shown in FIG. 2A, CHannels 1 to 20 (CH 1 to CH 20) are displayed on a screen. The list of channels is received via channel information such as ESG. It is assumed that CH 6 (201) has been selected from the list of channels according to a user's input. FIG. 2A shows that the selected CH 6 is being highlighted.

FIG. 2B illustrates a screen on which the user can select a plurality of channels 203. The selected channels CH 6, CH 10, CH 11 and CH 12 are being highlighted on the screen.

FIG. 2C illustrates a screen on which the selected channels 203 shown in FIG. 2B are removed. That is, if a command for cutting the highlighted selected channels 203 is input, the channels are removed from the screen and stored temporarily in a buffer. If a complete deletion command is input, the temporarily stored channels can be stored.

FIG. 2D illustrates a screen on which a cursor is placed in a position where the channel will be moved. Specifically, the area to which the channel will be moved is highlighted.

When a user's movement command is input while the area to which the channel will be moved is highlighted as shown in FIG. 2D, the selected channels CH 6, CH 10, CH 11 and CH 12, removed from the screen shown in FIGS. 2B and 2C and temporarily stored in the buffer, are pasted and displayed on a screen as shown in FIG. 2E.

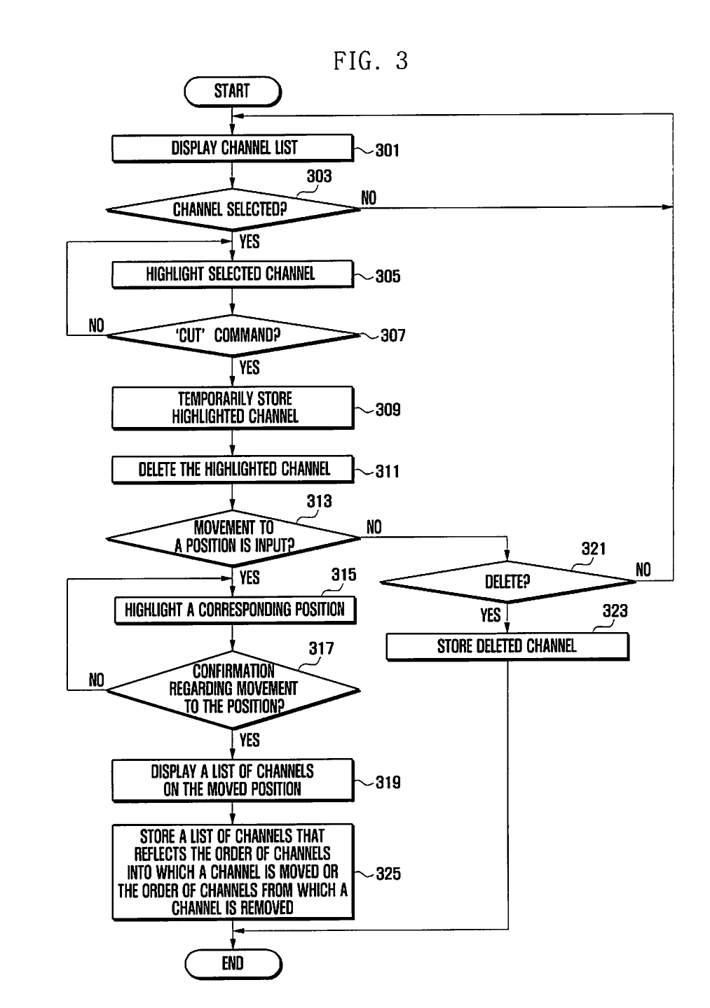

FIG. 3 illustrates a method for editing a list of digital broadcast channels in a mode for editing a list of digital broadcast channels, according to an embodiment of the present invention.

When the portable terminal is operated in a channel list edit mode according to a user's request, the controller 170 controls the display unit 130 to display a list of channels in preset order in step 301. The order of displaying channels may be a sequence where channels are extracted from an electronic guide, and stored in the storage unit 140. Also, the order of displaying channels may be a sequence in the list of channels for which order is altered according to the user's editing. The order of channels is shown in FIG. 2A.

The controller 170 detects whether a user's input for selecting a channel is input via the input unit 160 in step 303. The user's channel selection methods can be variously implemented according to the user interface. For example, if the user interface is implemented with a cursor or a highlighting mark, it can be moved to a position where a channel to be selected is displayed using the direction keys of the input unit 160. After that, the channel associated with the position of the cursor is selected by a function or by a preset key.

It is assumed that the user selects at least one of the channels displayed on the screen. When the controller 170 detects that a user's input for selecting a channel is input via the input unit 160 at step 303, it highlights and displays the selected channel in step 305, shown in FIGS. 2A and 2B. However, if the controller 170 detects that a user's input for selecting a channel is not input via the input unit 160 at step 303, it displays the list of channels at step 301.

When displaying the highlighted channel at step 303, the controller 170 determines whether a ‘Cut’ input signal is input via the input unit 160 in step 307. If the controller 170 ascertains that a ‘Cut’ input signal is input via the input unit 160 at step 307, it temporarily stores the highlighted channel in a buffer in step 309 and deletes it from the list of channels in step 311, shown in FIG. 2C. However, if the controller 170 ascertains that a ‘Cut’ input signal is not input via the input unit 160 at step 307, it highlights and displays the selected channel at step 305.

After deleting the highlighted channel at step 311, the controller 170 determines whether a position to which the temporarily stored channel will be moved is input in step 313. While the selected channel is being temporarily stored, the user can select a position to which the temporarily stored channel will be moved. The user's position selecting methods can be variously implemented according to the user interface. For example, if the user interface is implemented with a cursor, it can be moved to a position using the direction keys.

If the controller 170 ascertains that a position to which the temporarily stored channel will be moved is input at step 313, it highlights the position in step 315.

After that, the controller 170 determines whether a user's input is input to confirm that the temporarily stored channel is moved to the highlighted position in step 317. The position can be selected using a function key or a preset key. If the controller 170 ascertains that a user's input for confirming the position selection is input at 317, it moves the temporarily stored channel to the user's selected highlighted position and displays a list of channels for which the order is altered (319). However, if the controller 170 ascertains that a user's input for confirming the position selection is not input at step 317, it highlights the position in step 315.

If the controller 170 ascertains that a position to which the temporarily stored channel will be moved is not input at step 313, which also indicates that the user may delete the temporarily stored channel from the list of channels, the controller 170 determines whether the user inputs a deletion command in step 321. If the controller 170 ascertains that the user inputs a deletion command at step 321, it deletes the channel from the screen and stores it in a preset folder in step 323.

As described above, if a ‘Cut’ input command and a ‘Delete’ command are input, a corresponding channel is deleted from the screen. The input unit 160 includes a separate deletion key to delete a selected channel without using the ‘Cut’ input command. The deleted channels may be stored in a ‘list of deleted channels’ in order to be separately managed.

As described above, when a channel is moved to a certain position and displayed thereon or deleted from the screen, the controller 170 stores a list of channels that reflects the order of channels into which a channel is moved or from which a channel is removed in step 325.

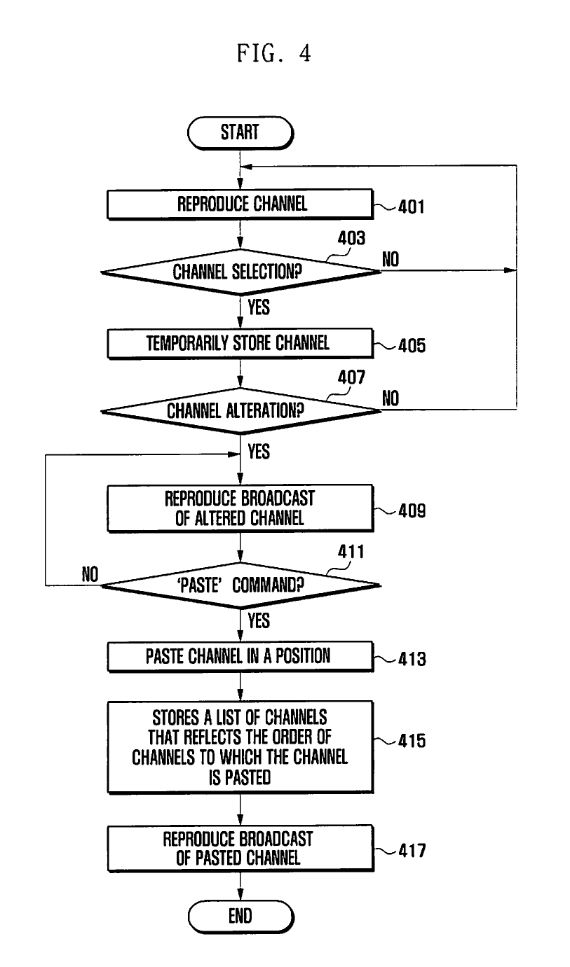

FIG. 4 illustrates a method for editing a list of digital broadcast channels during the digital broadcast viewing, according to another embodiment of the present invention.

It is assumed that the portable terminal is receiving and reproducing a digital broadcast. When a user selects one of the channels in a list, the controller 170 reproduces a broadcast of the selected channel on the display unit 130 in step 401. It is assumed that the channels are listed in order CH 1, CH 2, CH 3, CH 4, CH 5, CH 6, CH 7, CH 8, CH 9, and CH 10. It is also assumed that the user selected CH 10 and the portable terminal is receiving and reproducing a broadcast of CH 10.

While the broadcast is being reproduced, the controller 170 determines whether a user's channel selection is input in step 403. If the controller 170 ascertains that a user's channel selection is input at step 403, it temporarily stores the channel that is currently being reproduced, i.e., CH 10 in step 405.

The user can alter the channel that is currently being reproduced via a key input. That is, the controller 170 determines whether a channel alternation input is input in step 407. If the controller 170 ascertains that a channel alternation input is input at step 407, it alters the current channel to a user's input channel and reproduces the broadcast in step 409. For example, it is assumed that the user alters the current channel to CH 6 and the broadcast of CH 6 is reproduced.

While the broadcast of the altered channel is being reproduced, the controller 170 determines whether a ‘Paste’ command is input in step 411. During the viewing of the broadcast, the user can paste the temporarily stored channel before or after the channel that is currently being reproduced, using a function key or a preset key, thereby editing a list of channels. The ‘Paste’ command refers to a command to paste the temporarily stored channel preceding or following the channel that is currently being reproduced, where determining the preceding or following position is selected when the portable terminal or application program is developed.

When the controller 170 ascertains that a ‘Paste’ command is input at 411, it pastes the temporarily stored channel, i.e., CH 10, in a preset position, i.e., before or after CH 6 in step 413. The controller 170 then stores a list of channels that reflects the order of channels to which the channel is pasted in step 415. For example, if the ‘Paste’ command is set to paste the temporarily stored channel, CH 10, before the selected channel, CH 6, the channels are listed in order CH 1, CH 2, CH 3, CH 4, CH 5, CH 10, CH 6, CH 7, CH 8, and CH 9. The controller 170 then reproduces a broadcast of CH 10 in step 417.

A channel that the user does not want can be deleted from the list of channels while a broadcast of a channel is being reproduced. To this end, the user removes a channel via the ‘Paste’ command and then deletes it without performing the pasting action. Alternatively, the user deletes the channel using a ‘Delete’ key. The deleted channel may be stored in a list of deleted channels.

As described above, the apparatus and method for editing a list of digital broadcast channels, according to the present invention, allows a user to easily select one of the channels in list and move it to a position that the user desires, so that the user can intuitively edit the list of channels. The apparatus and method for editing a list of digital broadcast channels can also allow a user to select a plurality of channels from the list of channels and to easily edit them.

Although embodiments of the present invention have been described in detail hereinabove, it should be understood that many variations and modifications of the basic inventive concept herein described, which may be apparent to those skilled in the art, will still fall within the spirit and scope of the embodiments of the present invention as defined in the appended claims.

What is claimed is:

1. A method for editing a list of digital broadcast channels, comprising:
displaying a list of channels listed in order set according to channel information;
selecting at least one of the channels in the list, according to a user's input; and
moving, when a user selects a position in the listed channels, at least one selected channel to the selected position and displaying the at least one selected channel on the selected position.

2. The method of claim 1, further comprising:
storing a list of channels that reflects an order of channels into which at least one selected channel is moved.

3. The method of claim 1, wherein selecting at least one of the channels comprises:
temporarily storing the at least one selected channel.

4. The method of claim 3, wherein selecting at least one of the channels further comprises:
storing the at least one temporarily stored selected channel in a preset folder, when a request for deleting the at least one temporarily stored selected channel is input.

5. An apparatus for editing a list of digital broadcast channels, comprising:
a broadcast receiver for receiving channel information;
a display unit for displaying a list of channels listed in order set according to channel information;
an input unit for receiving a user's input; and
a controller for detecting that at least one of the channels in the list is selected according to the user's input, and moving, when the user selects a position in the listed channels, at least one selected channel to the selected position and displaying the at least one selected channel on the selected position.

6. The apparatus of claim 5, further comprising:
a storage unit for storing a list of channels that reflects an order of channels into which at least one selected channel is moved.

7. The apparatus of claim 5, wherein the controller temporarily stores at least one selected channel.

8. The apparatus of claim 7, wherein the controller stores the at least one temporarily stored selected channel in a preset folder, when a request for deleting the at least one temporarily stored selected channel is input.

9. A method for editing a list of digital broadcast channels, comprising:
temporarily storing, when a channel selection input is detected while a channel is being reproduced, the reproducing channel;
reproducing, when a channel alteration is detected, the altered channel; and
moving, when a channel edit command is input, the temporarily stored channel to a preset position and displaying the temporarily stored channel on the preset position.

10. The method of claim 9, further comprising:
storing a list of channels that reflects an order of channels into which the temporarily stored channel is moved.

11. The method of claim 9, wherein moving and displaying the temporarily stored channel comprises:
moving the temporarily stored channel before or after the position of the altered channel that is reproducing a broadcast; and
displaying the temporarily stored channel where it is moved.

12. An apparatus for editing a list of digital broadcast channels, comprising:
a broadcast receiver for receiving channel information;
a display unit for displaying a list of channels listed in order set according to channel information;
an input unit for receiving a user's input; and
a controller for temporarily storing a channel that is reproducing a broadcast when a channel selection input is detected, reproducing an altered channel when a channel alteration is detected, moving the temporarily stored channel to a preset position when a channel edit confirmation command is input, and displaying the temporarily stored channel on the preset position.

13. The apparatus of claim 12, further comprising:
a storage unit for storing a list of channels that reflects an order of channels into which the temporarily stored channel is moved.

14. The apparatus of claim 12, wherein the controller moves the temporarily stored channel before or after a position of the altered channel that is reproducing broadcast, and displays the temporarily stored channel where it is moved.
